(19) United States
(12) Patent Application Publication
(10) Pub. No.: US 2021/0016954 A1
(43) Pub. Date: Jan. 21, 2021

(54) CONTROLLED VENTING POUCH

(71) Applicant: Cryovac, LLC, Charlotte, NC (US)

(72) Inventors: Kemia Anders, Charlotte, NC (US); Olivia Stillman, Rock Hill, SC (US); Emily C. Gaither, Charlotte, NC (US)

(21) Appl. No.: 17/043,894

(22) PCT Filed: Apr. 3, 2019
(86) PCT No.: PCT/US2019/025492

§ 371 Date: Sep. 30, 2020

Related U.S. Application Data
(60) Provisional application No. 62/653,204, filed on Apr. 5, 2018.

(51) Int. Cl. B65D 81/34; B65D 65/40; B65D 75/12; B65D 75/52; B32B 27/06; B65B 9/08; B65B 25/22

(52) U.S. Cl. CPC B65D 81/3461; B65D 65/40; B65D 75/12; B65D 75/52; B32B 27/06; B65B 9/08; B65B 2220/08; B65D 2581/3404; B65D 2581/3416; B65D 2581/3422; B65D 2581/3427; B32B 2439/70; B32B 2439/46; B65B 25/22

(57) ABSTRACT

The presently disclosed subject matter is directed to a pouch for cooking a food product and a method of making a pouch for cooking The pouch for cooking a food product may have a film, a longitudinal seal so as to form a sealed tube, a first transverse seal at a first end of the pouch, and a second transverse seal at a second end of the pouch. The pouch may have a surface area to food product volume ratio from 3:1 to 9:1. The pouch may have at least one layer with at least 5% polybutylene. The longitudinal seal may extend from the first end of the pouch to the second end of the pouch. The longitudinal seal may seal the film to itself.

### CROSS-REFERENCE TO RELATED APPLICATIONS

This application claims the benefit of a prior-filed U.S. Provisional Application Ser. No. 62/653204, filed Apr. 5, 2018 and entitled “Controlled Venting Pouch,” the entirety of which is incorporated herein by reference.

### TECHNICAL FIELD

The present invention is in the technical field of food packaging. More particularly, the present invention is in the technical field of venting pouches to be used when cooking a food product in a venting pouch.

### BACKGROUND

Conventional food packaging that can be used for cooking a food product usually has a vent hole, perforations, or some kind of opening of the food pouch prior to heating. The difficulties of these types of food packaging are that the food product can leak out, exit, or explode out of the pouch and result in loss of the food product. Some self-venting food pouches are available, but these are not able to vent in a controlled manner and require a solid food product so that no food product exits the pouch. The present invention is directed to a controlled venting pouch for both solid and liquid food products. The present invention can be used on vertical and horizontal form fill and seal machines.

### SUMMARY

The presently disclosed subject matter is directed to a pouch for cooking a food product and a method of making a pouch for cooking a food product. The pouch for cooking a food product may have a film. The pouch may have a longitudinal seal so as to form a sealed tube, a first transverse seal at a first end of the pouch, and a second transverse seal at a second end of the pouch. The pouch may have a surface area to food product volume ratio from 3:1 to 22:1. The pouch may have at least one layer with at least 5% polybutylene. The longitudinal seal may extend from the first end of the pouch to the second end of the pouch. The longitudinal seal may seal the film to itself

The method for preparing a pouch for cooking a food product may include preparing a pouch. The pouch may have a film, a longitudinal seal so as to form a sealed tube, a first transverse seal at a first end of the pouch, and a second transverse seal at a second end of the pouch. The pouch may have a surface area to food product volume ratio from 3:1 to 9:1. The pouch may have at least one layer with at least 5% polybutylene. The longitudinal seal may extend from the first end of the pouch to the second end of the pouch. The longitudinal seal may seal the film to itself. The method may include sealing the pouch at a first end with a first transverse seal. The method may also include filling the pouch with a food product. Further, the method may include sealing the pouch at a second end with a second transverse seal. The second end may be opposite of the first end of the pouch.

### BRIEF DESCRIPTION OF DRAWINGS

FIG. 1 is a front view of an embodiment of the pouch of the present invention;

FIG. 2 is a back view of an embodiment of the pouch of the present invention;

FIG. 3A is a cross-sectional view of the pouch of FIG. 2, taken through section 205-205 of FIG. 2. FIG. 3B is a cross-sectional view of an embodiment of the pouch.

FIG. 4 is a perspective view of an embodiment of the pouch of the present invention placed in a container;

FIG. 5 is a schematic of a hot blown film process for making films to be used in the pouch of the present invention.

### DESCRIPTION OF EMBODIMENTS

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long standing patent law convention, the terms “a”, “an”, and “the” refer to “one or more” when used in the subject application, including the claims. Thus, for example, reference to “a formulation” includes a plurality of such formulations, and so forth.

Unless indicated otherwise, all numbers expressing quantities of components, reaction conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about,” when referring to a value or to an amount of mass, weight, time, volume, concentration, percentage, and the like can encompass variations of, and in some embodiments, ±20%, in some embodiments ±10%, in some embodiments ±5%, in some embodiments ±1%, in some embodiments ±0.5%, in some embodiments ±0.1%, and in some embodiments ±0.01%, from the specified amount, as such variations are appropriated in the disclosed film, pouch, container, and methods.

As used herein, the term “cooking” refers to any method of heating or re-heating that may increase the temperature of a food product.

As used herein, the term “controlled venting” or “controlled vent” refers to a venting mechanism or vent during cooking of a film, pouch, or container that allows for an area of a seal in the film, pouch, or container to open and the venting mechanism or vent does not result in the food product exiting out of the film, pouch, or container.

As used herein, the term “film” is inclusive of plastic web, regardless of whether it is film or sheet. The film can have a thickness of 0.25 mm or less, or a thickness of from 0.5 to 30 mils, or from 0.5 to 15 mils, or from 1 to 10 mils, or from 1 to 8 mils, or from 1.1 to 7 mils, or from 1.2 to 6 mils, or from 2.5 to 6 mils, or from 1.3 to 5 mils, or from 1.5 to 4 mils, or from 1.6 to 3.5 mils.

As used herein, the noun “bond” and the verb “to bond” and “bonded” include all forms of bonding, including the many forms of heat sealing (e.g., impulse sealing, laser sealing, trim sealing, etc.) as well as adhesive bonding. As used herein, the terms “bond” and “seal” are used interchangeably, both covering bonding by heat and bonding using adhesive. The phrase “heat seal” refers to a bond made using heat and pressure.

As used herein, all references to AS™ tests correspond with the most recent version of the AS™ test as of Apr. 1, 2018.

As used herein, the symbols “Tg” and “T_{g}” are used with reference to the glass transition temperature of a polymer. Unless otherwise indicated, the glass transition temperature of the polymer was determined by the Perkin Elmer “half Cp extrapolated” (the “half Cp extrapolated” reports the point on the curve where the specific heat change is half of the change in the complete transition) following the AS™ D3418 “Standard Test Method of Transition Temperatures of Polymers by Thermal Analysis,” which is hereby incorporated, in its entirety, by reference thereto.

As used herein, the phrase “tie layer” refers to any internal layer having the primary purpose of adhering two layers to one another. Tie layers can comprise any polymer having a polar group grafted thereon. Such polymers adhere to both nonpolar polymers such as polyolefin, as well as polar polymers such as polyamide and ethylene/vinyl alcohol copolymer. Tie layers can be made from polyolefins such as modified polyolefin, ethylene/vinyl acetate copolymer, modified ethylene/vinyl acetate copolymer, and homogeneous ethylene/alpha-olefin copolymer. Typical tie layer polyolefins include anhydride modified grafted linear low density polyethylene, anhydride grafted (i.e., anhydride modified) low density polyethylene, anhydride grafted polypropylene, anhydride grafted methyl acrylate copolymer, anhydride grafted butyl acrylate copolymer, homogeneous ethylene/alpha-olefin copolymer, maleic-anhydride modified polyethylene, maleic-anhydride modified linear low density polyethylene, and anhydride grafted ethylene/vinyl acetate copolymer.

“Ethylene homopolymer or copolymer” herein refers to ethylene homopolymer such as low density polyethylene; ethylene/alpha olefin copolymer such as those defined hereinbelow; and other ethylene copolymers such as ethylene/vinyl acetate copolymer; ethylene/alkyl acrylate copolymer; ethylene/(meth)acrylic acid copolymer; or ionomer resin.

“Ethylene/alpha-olefin copolymer” (EAO) herein refers to copolymers of ethylene with one or more comonomers selected from C₄ to C₁₀ alpha-olefins such as butene-1,hexene-1, octene-1, etc. in which the molecules of the copolymers comprise long polymer chains with relatively few side chain branches arising from the alpha-olefin which was reacted with ethylene. This molecular structure is to be contrasted with conventional high pressure low or medium density polyethylenes which are highly branched with respect to EAOs and which high pressure polyethylenes contain both long chain and short chain branches. EAO includes such heterogeneous materials as linear medium density polyethylene (LMDPE), linear low density polyethylene (LLDPE), and very low and ultra low density polyethylene (VLDPE and ULDPE, respectively), such as DOWLEX™ or ATTANETM resins supplied by Dow, ESCORENE™ or EXCEED™ resins supplied by Exxon; as well as linear homogeneous ethylene/alpha olefin copolymers (HEAO) such as TAFMER™ resins supplied by Mitsui Petrochemical Corporation, EXACT™ resins supplied by Exxon, or long chain branched (HEAO) AFFINITY™ resins supplied by the Dow Chemical Company, or ENGAGE™ resins supplied by DuPont Dow Elastomers.

“High density polyethylene” (HDPE) herein refers to a polyethylene having a density of between 0.941 and 0.965 grams per cubic centimeter.

“Intermediate layer” herein refers to a layer of a multilayer film which is between an outer layer and an inner layer of the film.

“Inner layer” herein refers to a layer which is not an outer or surface layer, and is typically a central or core layer of a film.

“Low density polyethylene” (LDPE) herein refers to a polyethylene having a density of between 0.910 and 0.940 grams per cubic centimeter.

“Linear low density polyethylene” (LLDPE) herein refers to polyethylene having a density between 0.917 and 0.925 grams per cubic centimeter.

“Linear medium density polyethylene” (LMDPE) herein refers to polyethylene having a density between 0.926 grams per cubic centimeter and 0.939 grams per cubic centimeter.

“Outer layer” herein refers to what is typically an outermost, usually surface layer or skin layer of a multilayer film, although additional layers, coatings, and/or films can be adhered to it.

“Polyamide” herein refers to polymers having amide linkages along the molecular chain, and preferably to synthetic polyamides such as nylons. Furthermore, such term encompasses both polymers comprising repeating units derived from monomers, such as caprolactam, which polymerize to form a polyamide, as well as polymers of diamines and diacids, and copolymers of two or more amide monomers, including nylon terpolymers, sometimes referred to in the art as “copolyamides.” “Polyamide” specifically includes those aliphatic polyamides or copolyamides commonly referred to as e.g. polyamide 6 (homopolymer based on ε-caprolactam), polyamide 69 (homopolycondensate based on hexamethylene diamine and azelaic acid), polyamide 610 (homopolycondensate based on hexamethylene diamine and sebacic acid), polyamide 612 (homopolycondensate based on hexamethylene diamine and dodecandioic acid), polyamide 11 (homopolymer based on 11-aminoundecanoic acid), polyamide 12 (homopolymer based on w-aminododecanoic acid or on laurolactam), polyamide 6/12 (polyamide copolymer based on E-caprolactam and laurolactam), polyamide 6/66 (polyamide copolymer based on E-caprolactam and hexamethylenediamine and adipic acid), polyamide 66/610 (polyamide copolymers based on hexamethylenediamine, adipic acid and sebacic acid), modifications thereof and blends thereof. Said term also includes crystalline or partially crystalline, aromatic or partially aromatic, polyamides.

“Polymer” herein refers to homopolymer, copolymer, terpolymer, etc. “Copolymer” herein includes copolymer, terpolymer, etc.

As used herein, the term “seal” refers to any seal of a first region of an outer film surface to a second region of an outer film surface, including heat or any type of adhesive material, thermal or otherwise. In some embodiments, the seal can be formed by heating the regions to at least their respective seal initiation temperatures. The sealing can be performed by any one or more of a wide variety of methods, including (but not limited to) using a heat seal technique (e.g., melt-bead sealing, thermal sealing, impulse sealing, dielectric sealing, radio frequency sealing, ultrasonic sealing, hot air, hot wire, infrared radiation).

As used herein, the phrases “seal layer”, “sealing layer”, “heat seal layer”, and “sealant layer”, refer to an outer film layer, or layers, involved in the sealing of the film to itself, another film layer of the same or another film, and/or another article that is not a film. It should also be recognized that in general, up to the outer 1-10 mils of a film can be involved in the sealing of the film to itself or another layer. In general, a sealant layer sealed by heat-sealing layer comprises any thermoplastic polymer. In some embodiments, the heat-sealing layer can comprise, for example, thermoplastic polyolefin, thermoplastic polyamide, thermoplastic polyester, and thermoplastic polyvinyl chloride. In some embodiments, the heat-sealing layer can comprise thermoplastic polyolefin.

As used herein, the term “frangible seal” refers to a seal which is sufficiently durable to allow normal handling of a film, pouch, or container under ambient temperature conditions without breaking, yet which will peel or substantially separate under the influence of elevated temperatures and/or pressure.

All compositional percentages used herein are presented on a “by weight” basis, unless designated otherwise.

The pouch for cooking a food product may have a film. The pouch may be made from a single piece of film. The film may be a multilayer film. In some embodiments, the film may have at least one sealant layer, at least one tie layer, at least one barrier layer, and at least one skin layer. In other embodiments, the film may have the following layers:

sealant/tie/barrier/barrier/barrier/tie/skin;
sealant/tie/barrier/tie/skin;
sealant/tie/barrier/barrier/tie/skin;
sealant/barrier/barrier/barrier/skin;
sealant/barrier/barrier/skin
sealant/barrier/skin

The film may have a sealant layer. The sealant layer may have polybutylene. The sealant layer may have polybutylene and may be an inside layer of the pouch. The sealant layer may have 5% to 30% polybutylene. The sealant layer may have 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 40%, 45%, 50% polybutylene, or any range between these values. In an embodiment, the sealant layer has at least 15% polybutylene. In some embodiments, the sealant layer may have 20% polybutylene. The sealant layer may have polyethylene. The polyethylene may be low density polyethylene (LDPE), linear low density polyethylene (LLDPE), ultra low density polyethylene (ULDPE), or very low density polyethylene (VLDPE). The sealant layer may have LLDPE. The sealant layer may have modified-LLDPE (LLDPE-md). The sealant layer may also include at least one of ethylene copolymer, or ethylene/vinyl acetate copolymer (EVA) The sealant layer may also include at least one additive. The at least one additive may be an antiblock, an antifogging agent, an antioxidant, a slip agent, a fluoropolymer, a siloxane, or combinations thereof

In some embodiments, the sealant layer may have 5% to 75% polyethylene. The sealant layer may have 5% to 30% EVA. The sealant layer may have 0.1% to 15% of an additive. In some embodiments, the sealant layer may have 30% to 75% LLDPE. The sealant layer may have 1% to 15% antiblock. The sealant layer may have 0.1% to 10% of a slip agent. The sealant layer may have 1% to 10% of a colorant. The sealant layer may have 0.1% to 5% of a fluoropolymer. The antiblock, slip agent, colorant, and fluoropolymer may be blended in polyethylene. The additives may be blended separately in polyethylene. In some embodiments, the additives may be blended in combination in polyethylene. The sealant layer may have 54% LLDPE, 18% EVA, 20% polybutylene, 5% antiblock and slip agent in LLDPE, 2% polydimethylsiloxane in LDPE, and 1% fluoropolymer in LLDPE.

The film may have at least one tie layer. The film may have at least one tie layer adapted for improving the adherence of one layer of the film to another layer of the film. The tie layer may be LLDPE. The tie layer may be LLDPE-md. The tie layer may be maleic-anhydride-modified LLDPE. The film may have 2 tie layers. The film may have a plurality of tie layers.

The film may have at least one barrier layer. The barrier layer may also be referred to as the abuse layer. The terms “barrier layer” and “abuse layer” may be used interchangeably. The barrier layer may have EVOH, polyamide, EVOH blend, PGA, or combinations thereof. The barrier layer may be adjacent to the tie layer. In some embodiments, the barrier layer may be adjacent to the sealant layer. In some embodiments, the film may have 2 barrier layers. In other embodiments, the film may have 3 barrier layers. In further embodiments, the film may have 4 barrier layers. In yet further embodiments, the film may have 5 barrier layers.

Polyamides are known in the art and include polymers having amide linkages (such as synthetic polyamides) and can be either aliphatic or aromatic and either in semi-crystalline or amorphous form. Suitable polyamides can include both polyamides and co-polyamides. In some embodiments, suitable polyamides can be selected from nylon compounds approved for use in producing articles intended for use in processing, handling, and packaging, including the homopolymers, copolymers, and mixtures of the nylon materials described in 21 C.F.R. 177.1500 et seq., incorporated herein in its entirety.

For example, exemplary polyamides can include (but are not limited to) nylon homopolymers and copolymers such as those selected from the group comprising: nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-laurallactam)), nylon 6,6/6 (poly(hexamethylene adipamide-co-caprolactam)), nylon 6/66 (poly(caprolactam-co-hexamethylene adipamide)), nylon 66/610 (e.g., manufactured by the condensation of mixtures of nylon 66 salts and nylon 610 salts), nylon 6/69 resins (e.g., manufactured by the condensation of epsilon-caprolactam, hexamethylenediamine and azelaic acid), nylon 11 (polyundecanolactam), nylon 12 (polyauryllactam), nylon MXD6, nylon MXDI, nylon 6I/6T, and copolymers or mixtures thereof.

As would be known to those of ordinary skill in the art, EVOH is a copolymer consisting essentially of ethylene and vinyl alcohol recurring structural units and can contain small amounts of other monomer units, such as vinyl ester units. EVOH can be prepared by saponification, partial alcoholysis of ethylene-vinyl ester copolymers, and/or complete alcoholysis of ethylene-vinyl ester copolymers.

The pouch may have a skin layer. The skin layer may have LLDPE. In some embodiments, the skin layer may have LDPE and LLDPE. The skin layer may have polyethylene, LDPE, LLDPE, ULDPE, VLDPE, or combinations thereof. The skin layer may also have an additive. The additive may be antiblock, slip agent, colorant, dye, antifogging agents, antioxidants, fluoropolymer, or combinations thereof. The skin layer may have 30% to 75% LLDPE. The skin layer may have 5% to 35% antiblock. The skin layer may have 1% to 10% of a slip agent. The skin layer may have 1% to 10% of a colorant. The skin layer may have 0.1% to 5% of a fluoropolymer. The antiblock, slip agent, colorant, and fluoropolymer may be blended in polyethylene.

In some embodiments, the skin layer may have LLDPE, LDPE with antiblock, LLDPE with antiblock and slip, colorant in LLDPE, and a fluoropolymer in LLDPE. In other embodiments, the skin layer may have LLDPE, LDPE with antiblock, LLDPE with antiblock and slip, orange colorant in LLDPE, and a fluoropolymer in LLDPE. In further embodiments, the skin layer may have 66% LLDPE, 22% LDPE with antiblock, 5% LLDPE with antiblock and slip, 6% orange colorant in LLDPE, and 1% fluoropolymer in LLDPE.

There is generally no limit to the number of layers used for the multilayer film structure of the pouch. Accordingly, the film may have 1 layer, 2 layers, 3 layers, 4 layers, 5 layers, 6 layers, 7 layers, 8 layers, 9 layers, 10 layers, 11 layers, 12 layers, 13 layers, 14 layers, 15 layers, 16 layers, 17 layers, 18 layers 19 layers, 20 layers, or any range between these values. In some embodiments, the film may have 6 layers. In other embodiments, the film may have 7 layers. In further embodiments, the film may have 8 layers.

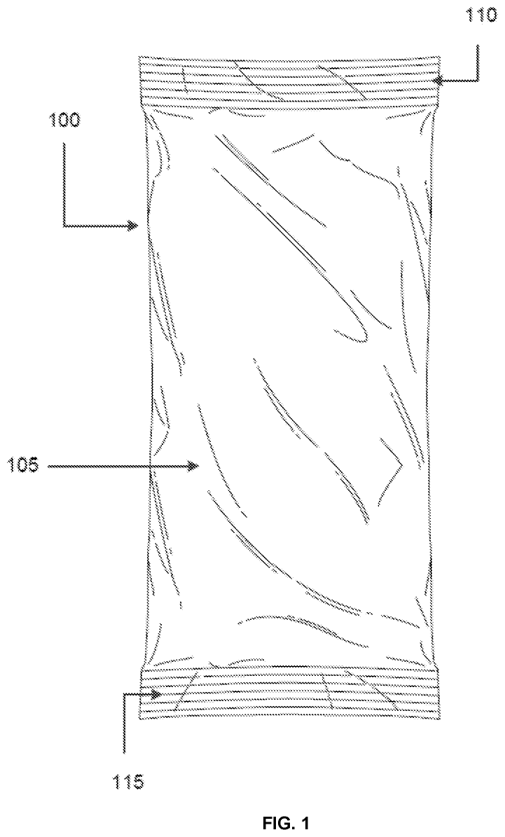

FIG. 1 is a front view of an embodiment of the pouch 100 of the present invention. The pouch 100 may have a film 105. The pouch 100 may be made from a single film 105. The pouch 100 may have a first transverse seal 110 at a first end of the pouch 100. The pouch 100 may have a second transverse seal 115 at a second end of the pouch 100. The second end may be opposite of the first transverse seal at the first end of the pouch. The first transverse seal 110 and the second transverse seal 115 may have at least one rib. In some embodiments, the first transverse seal 110 and the second transverse seal 115 may have a plurality of ribs. The first transverse seal 110 and the second transverse seal 115 may have 1 rib, 2 ribs, 3 ribs, 4 ribs, 5 ribs, 6 ribs, 7 ribs, 8 ribs, 9 ribs, 10 ribs, 11 ribs, 12 ribs, 13 ribs, 14 ribs, 15 ribs, or any range between these values. The first transverse seal 110 and the second transverse seal 115 may be a heat seal. The heat seal may be impulse sealing, laser sealing, trim sealing, or any other heat seal known in the art. The first transverse seal 110 and the second transverse seal 115 may be a frangible seal. The first transverse seal 110 and the second transverse seal 115 may have a sealant composition that forms a frangible seal at the first transverse seal 110 and the second transverse seal 115.

The first transverse seal 110 may be sealed before a food product is added. The first transverse seal 110 may be sealed after a food product is added. The second transverse seal 115 may be sealed after a food product is added. The second transverse seal 115 may be sealed before a food product is added. The pouch may be filled with a food product. The sealant composition of the first and/or second transverse seal may soften and weaken at elevated temperatures. Elevated temperatures occur during cooking of the pouch once a food product has been added. Sufficient heating of the pouch causes moisture vapor to accumulate within the interior of the pouch 100. Heating of the pouch at elevated temperatures also causes the sealant composition to soften and weaken. When pressure due to the accumulation of moisture vapor inside the pouch exceeds the strength of the frangible seal, the frangible seal breaks and creates an opening through which the moisture vapor can escape from the interior of the pouch. Once the seal breaks and creates an opening, this is a vent. The vent is an area of a seal in the film, pouch, or container that may vent open. The vent may be at the first transverse seal or the second transverse seal. The vent may be a controlled vent.

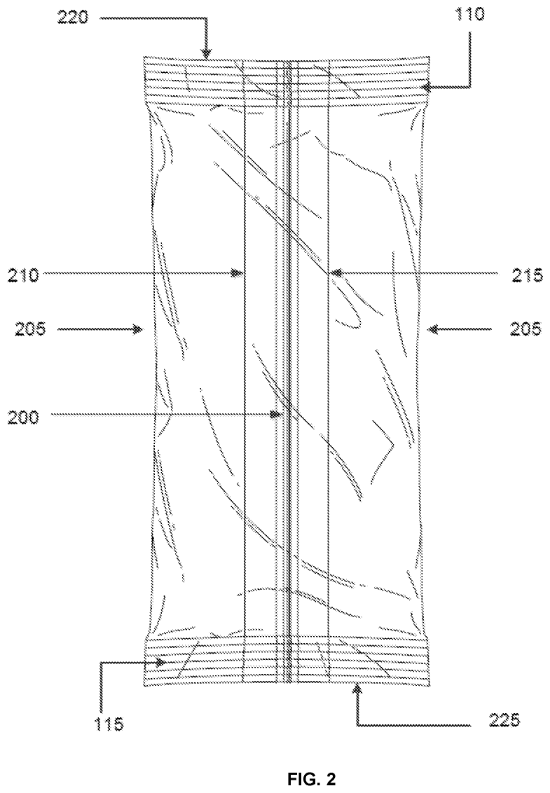

FIG. 2 is a back view of an embodiment of the pouch 100 of the present invention. In some embodiments, the pouch 100 may be made from a single piece of film 105. The pouch 100 may have a longitudinal seal 200. The longitudinal seal 200 may be used to form a sealed tube. The pouch 100 may be the sealed tube. The pouch 100 may have with a first transverse seal 110 and a second transverse seal 115. The longitudinal seal 200 may extend from the first end 220 of the pouch 100 to the second end 225 of the pouch 100. The longitudinal seal 200 may be a lap seal. In some embodiments, the longitudinal seal 200 may be a center lap seal. In other embodiments, the longitudinal seal 200 may be a lap seal at any location on the back side of the pouch 100. The longitudinal seal 200 may seal the film to itself.

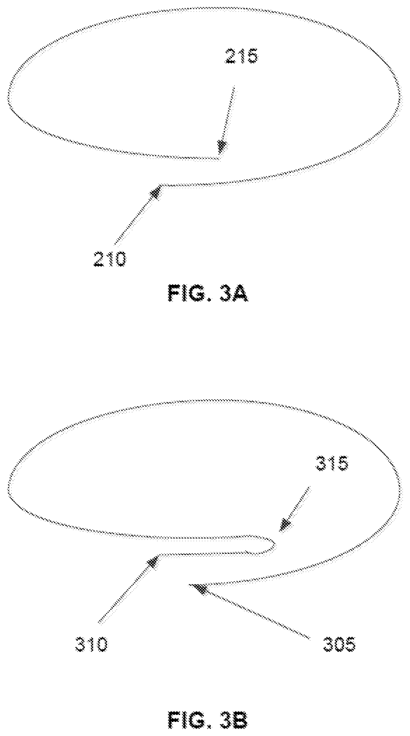

FIG. 3A is a cross-sectional view of the pouch of FIG. 2, taken through section 205-205 of FIG. 2. FIG. 3A shows the longitudinal edges 210 and 215 (as shown in FIG. 2) of the pouch 100 before a lap seal would be made. A lap seal is not illustrated in the cross-sectional view in FIG. 3A. The longitudinal seal 200 in FIG. 2 is a lap seal and the pouch 100 is made from a single piece of film 105. FIG. 3B is a cross-sectional view of an embodiment of the pouch 100 of FIG. 2, taken through section 205-205 of FIG.2. FIG. 3B shows the longitudinal edges 305 and 310 of an embodiment of the pouch 100 before a backseam fin seal would be made. A fin seal is not illustrated in the cross-sectional view in FIG. 3B. In an embodiment, a single piece of film 105 would have a longitudinal edge 310 created by a fold 315 on one side of the film and a second longitudinal edge 305 would be used to create a backseam fin seal.

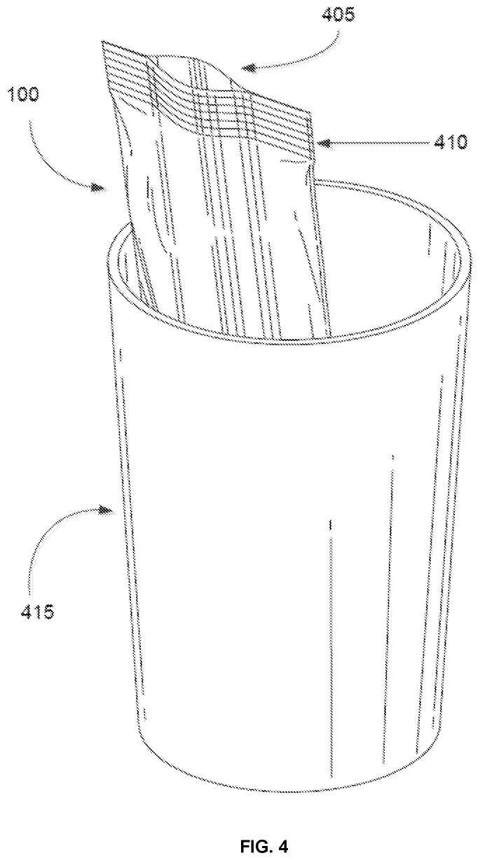

FIG. 4 illustrates an embodiment of the pouch 100 placed in a container 415 after cooking has been completed. The container 415 may be needed for cooking if the food product may leak out during cooking if the pouch 100 was not in a vertical position during cooking. In some embodiments, the pouch 100 may not need a container 415. In some embodiments, the pouch 100 may lay flat while cooking. In other embodiments, the pouch 100 may stand alone while cooking.

A controlled vent 405 may be formed at one end 410 of the pouch 100. The controlled vent 405 may be formed at the first transverse seal 110 or the second transverse seal 115. The controlled vent 405 will occur at the end where the frangible seal has opened and results in a vent from the pressure accumulating during the cooking of the food product in the pouch 100 and the accumulation of moisture vapor inside the pouch 100. In some embodiments, the controlled vent 405 will occur at the end 410 of the pouch that is at the top of the pouch 100 when it is in the container 415. In another embodiment, the controlled vent will occur at one end of the pouch while the pouch is lying flat. The controlled vent may be an adhesive failure. The controlled vent may be an adhesive failure at the sealant layer. The controlled vent may have no delamination of the film. The controlled vent may have delamination of the film.

When the pouch lays flat while cooking, a controlled vent may be more difficult to occur. A controlled vent may occur when the pouch lays flat while cooking when the moisture vapor can escape from the interior of the pouch without being blocked by a food product. If the food product blocks the first end and the second end during cooking, the moisture vapor cannot escape from the interior of the pouch without the food product also escaping and exiting the pouch. In this case, a controlled vent may not occur. A vent may occur, but it will not be controlled as the food product may exit the pouch. A pouch with a solid food product may be able to have a controlled vent. A pouch with a liquid food product that may turn solid while cooking may be able to have a controlled vent. In some embodiments, a pouch with a food product that has a viscous product (e.g. mashed potatoes, macaroni cheese) may be able to have a controlled vent during cooking.

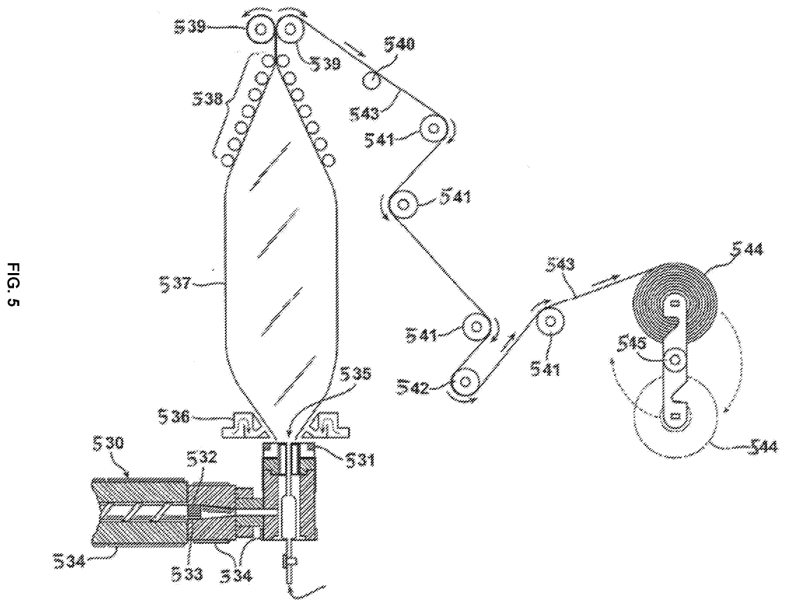

The film 105 used to make the pouch 100, may be made by a process as illustrated in FIG. 5, which illustrates a schematic view of rocess for making a non-heat shrinkable film, i.e., a “hot-blown” film 105, which is oriented in the melt state and is not heat shrinkable. Although only one extruder 530 is illustrated in FIG. 5, there can be more extruders, such as 2 or 3 extruders. Extruder 530 supplies molten polymer to annular die 531 for the formation of the film 105, which can be monolayer or multilayer, depending upon the design of the die and the arrangement of the extruder(s) relative to the die, as known to those of skill in the art. Extruder 530 is supplied with polymer pellets (not illustrated) suitable for the formation of the film 105. Extruder 530 subjects the polymer pellets to sufficient heat and pressure to melt the polymer and forward the molten stream through die 531.

Extruder 530 is equipped with screen pack 532, breaker plate 533, and heaters 534. The film 105 is extruded between mandrel 535 and die 531, with the resulting extrudate being cooled by cool air from air ring 536. The molten extrudate is immediately blown into blown bubble 537, forming a melt oriented film. The melt oriented film cools and solidifies as it is forwarded upward along the length of bubble 537. After solidification, the film tubing passes through guide rollers 538 and is collapsed into a lay-flat configuration by nip rollers 539. The collapsed film tubing is optionally passed over treater bar 540, and thereafter over idler rollers 541 and around dancer roller 542 which imparts tension control to collapsed film tubing 543, after which collapsed film tubing 543 is wound up as roll 544 via winder 545.

The pouch 100 may be filled and sealed by a vertical flow wrap process, also known as a vertical form fill and seal process. Vertical form fill and seal (“VFFS”) packaging systems have proven to be useful in packaging a wide variety of food and non-food pumpable products. One example of such a system is the Onpack™ packaging system marketed by Cryovac/Sealed Air Corporation (Charlotte, N.C., United States of America). The VFFS process is known to those of ordinary skill in the art, and is described in U.S. Pat. No. 4,589,247 to Tsuruta et al.; U.S. Pat. No. 4,656,818 to Shimoyama et al.; U.S. Pat. No. 4,768,411 to Su; and U.S. Pat. No. 4,808,010 to Vogan, inter alia, all incorporated herein in their entireties by reference thereto.

In a VFFS process, lay-flat thermoplastic film is first advanced over a forming device to form a tube. Next, a longitudinal (vertical) fin or lap seal is made, and a bottom end seal is formed by transversely sealing across the tube with heated seal bars. A pumpable product is introduced through a central, vertical fill tube to the formed tubular film. The pouch is then completed by sealing the upper end of the tubular segment, and severing the pouch from the tubular film above it. The process can be a two-stage process wherein the creation of a transverse heat seal occurs at one stage of the process, and downstream of the first stage, a separate pair of cooling/clamping means contact the newly-formed transverse heat seal to cool and thus strengthen the seal. In some VFFS processes, an upper transverse seal of a first pouch and the lower transverse seal of a following pouch are made. The pouches are then cut and thereby separated between two portions of the transverse seals without the need for a separate step to clamp, cool, clamp, cool, and cut the seals. A commercial example of an apparatus embodying the more simplified process is the Onpack™ 2050A VFFS packaging machine marketed by Cryovac/Sealed Air Corporation.

In some embodiments, the pouch 100 may be generated by a horizontal flow wrap process, also known as a horizontal form fill and seal (“HFFS”) process. The HFFS process is described in U.S. Publication No. 2017-0144416-A1, which this publication is hereby incorporated, in its entirety, by reference thereto.

The pouch may have a surface area to food product volume ratio in English or S.I. units. The surface area to food product volume ratio may be in square inches (in²) to fluid ounces (oz). The pouch may have a surface area to food product volume ratio of 3:1 to 10:1 in²/fluid oz. The food product volume, herein refers to the volume of food product that is in the pouch. In some embodiments, the pouch may have a surface area to food product volume ratio of 3.5:1 to 8:1. The pouch may have a surface area to food product volume ratio of 3:1, 3.1:1, 3.2:1, 3.3:1, 3.4:1, 3.5:1, 3.6:1, 3.7:1, 3.8:1, 3:9:1, 4:1, 4.1:1, 4.2:1, 4.3:1, 4.4:1, 4.5:1, 4.6:1, 4.7:1, 4.8:1, 4.9:1, 5:1, 5.1:1, 5.2:1, 5.3:1, 5.4:1, 5.5:1, 5.6:1, 5.7:1, 5.8:1, 5.9:1, 6:1, 6.1:1, 6.2:1, 6.3:1, 6.4:1, 6.5:1, 6.6:1, 6.7:1, 6.8:1, 6.9:1, 7:1, 7.1:1, 7.2:1, 7.3:1, 7.4:1, 7.5:1, 7.6:1, 7.7:1, 7.8:1, 7.9:1, 8:1, 8.25:1, 8.5:1, 8.75:1, 9:1, 9.25:1, 9.5:1, 9.75:1, 10:1, 11:1, 12:1, 13:1, 14:1, 15:1, 16:1, 17:1, 18:1, 19:1, 20:1, 21:1, 22:1, or any range between these values. In some embodiments, the pouch may have a surface area to food product volume ratio of 3.7:1. In other embodiments, the pouch may have a surface area to food product volume ratio of 5:1. In further embodiments, the pouch may have a surface area to food product volume ratio of 4.5:1. The surface area to food product volume ratio may allow for some volume within the pouch to have no food product.

The surface area to food product volume ratio may be converted in equivalent S.I. units. The surface area to food product volume ratio may be in square millimeters (mm²) to milliliter (ml). The pouch may have a surface area to food product volume ratio of 70:1 to 500:1 mm²/ml. The food product volume, herein refers to the volume of food product that is in the pouch. In some embodiments, the pouch may have a surface area to food product volume ratio of 80:1 to 200:1. The pouch may have a surface area to food product volume ratio of 70:1, 75:1, 80:1, 85:1, 90:1, 95:1, 100:1, 105:1, 110:1, 115:1, 120:1, 121:1, 122:1, 123:1, 124:1, 125:1, 130:1, 135:1, 140:1, 145:1, 150:1, 155:1, 160:1, 165:1, 175:1, 180:1, 185:1, 190:1, 195:1, 200:1, 205:1, 210:1, 215:1, 220:1, 225:1, 230:1, 235:1, 240:1, 245:1, 250:1, 300:1, 400:1, 500:1 or any range between these values. In some embodiments, the pouch may have a surface area to food product volume ratio of 84:1. In other embodiments, the pouch may have a surface area to food product volume ratio of 185:1. In further embodiments, the pouch may have a surface area to food product volume ratio of 123:1. The surface area to food product volume ratio may allow for some volume within the pouch to have no food product.

In an embodiment, the pouch may have a length of 150 mm to 310 mm. The pouch may have a length of 180 mm to 210 mm. In some embodiments, the pouch may have a length of 180 mm. In some embodiments, the pouch may have a length of 190 mm. In other embodiments, the pouch may have a length of 200 mm. In further embodiments, the pouch may be made from a film, and the film may have a length of 210 mm. The film may have a length of 220 mm. The film may have a length of 230 mm. The film may have a length of 240 mm. The film is then made into a pouch using a vertical form fill and seal machine with a longitudinal seal and two end seals. The pouch may have a width of 75 mm to 160 mm. In some embodiments, the pouch may have a width of 100 mm.

A method for preparing a pouch for cooking a food product is disclosed. The method for preparing a pouch for cooking may include preparing a pouch. The pouch may have a film. The pouch may have a longitudinal seal so as to form a sealed tube. The pouch may also have a first transverse seal at a first end of the pouch. The pouch may also have a second transverse seal at a second end of the pouch. The pouch may have a surface area to food product volume ratio from 3:1 to 22:1. The pouch may have at least one layer with at least 5% polybutylene. The longitudinal seal may extend from the first end of the pouch to the second end of the pouch. The longitudinal seal may seal the film to itself

Further, the method may include sealing the pouch at a first end with a first transverse seal. The first transverse seal may be a heat seal. The first transverse seal may have at least one rib. The first transverse seal may have 2 ribs, 3 ribs, 4 ribs, 5 ribs, 6 ribs, 7 ribs, 8 ribs, 9 ribs, 10 ribs, or any range between these values. The first transverse seal may have five ribs.

The method may also include filling the pouch with a food product. The food product may be filled by means of a VFFS machine. In some embodiments, the food product may be filled by means of a HFFS machine. The food product may be a solid or a liquid. The food product may be water, macaroni and cheese, mashed potatoes, diced vegetables, diced fruit, eggs, soup, gravy, sauces, whole meat, diced meat, rice, grains, non-sauced pasta, partially cooked pasta, pasta/sauce blends, whole vegetables, fruit fillings, fruit syrups, ground meat, or combinations thereof. The food product may be mashed potatoes. The food product may be a soup. The food product may be macaroni and cheese. The step of filling the pouch with a food product may be filled by means of a VFFS machine. In some embodiments, the step of filling the pouch with a food product may be filled by means of a HFFS machine.

Further, the method may include sealing the pouch at a second end with a second transverse seal. The second transverse seal may be a heat seal. The second transverse seal may have at least one rib. The second transverse seal may have 2 ribs, 3 ribs, 4 ribs, 5 ribs, 6 ribs, 7 ribs, 8 ribs, 9 ribs, 10 ribs, or any range between these values. The second transverse seal may have five ribs.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### EXAMPLES

The following examples are provided to illustrate various embodiments of films, and pouches made therefrom. In light of the present disclosure and the general level of skill in the art, those of ordinary skill in the art will appreciate that the following examples are intended to be exemplary only and that numerous changes, modifications, and alterations can by employed without departing from the scope of the presently disclosed subject matter.

### Example 1: Pouch and Film Formulations

The various resins and other components used in the making of the films are provided in Table 1, below. Melt flow rates were tested with AS™ D1238.

TABLE 1

| | | | Melt flow | Melt flow | Melt flow | |
|---|---|---|---|---|---|---|
| Resin Generic | | | rate Min | nominal | rate Max | |
| Name | Acronyms | Chemical Nature | (g/10 min) | (g/10 min) | (g/10 min) | Supplier |
| Polyethylene, | LLPDE | Polyethylene, Linear | 0.90 | 1.0 | 1.1 | Dow |
| Linear Low | | Low Density | | | | |
| Density | | Ethylene/Octene | | | | |
| (LLDPE) | | Copolymer | | | | |
| Ethylene | EVA | Ethylene/Vinyl | 0.6 | 0.7 | 0.8 | DuPont |
| Copolymer | | Acetate Copolymer - | | | | |
| | | Between 10-20% | | | | |
| | | comonomer | | | | |
| Polybutylene | PB | Polybutylene, | 0.6 | 1 | 1.1 | Lyondell |
| | | Butene/Ethylene | | | | Basell |
| | | Copolymer | | | | Industries |
| AntiBlock and | LLDPE-block | AntiBlock and Slip | 1.2 | 2.0 | 2.8 | Ampacet |
| Slip | | in Polyethylene, | | | | |
| | | Linear Low Density | | | | |
| Slip | LLDPE-slip | Polydimethylsiloxane | — | 8.0 | — | Dow Corning |
| | | in Polyethylene, | | | | |
| | | Low Density - High | | | | |
| | | Molecular Weight | | | | |
| | | Siloxane | | | | |
| Processing Aid | LLDPE-fluor | Fluoropolymer in | 1.4 | 2.3 | 3.2 | Ampacet |
| | | Polyethylene | | | | |
| Tie | LLDPE-md | Maleic Anhydride- | 1.9 | 2.3 | 2.9 | Westlake |
| | | Modified | | | | Chemical |
| | | Polyethylene, Linear | | | | |
| | | Low Density | | | | |
| Polyamide | PA-6 | Polyamide - 6, | 2.6 | 2.6 | 2.6 | AdvanSix |
| | | Lubricated and | | | | |
| | | Nucleated | | | | |
| Ethylene/Vinyl | EVOH/EVAL | Hydrolyzed | 1.3 | 1.7 | 2.1 | EVALCA/ |
| Alcohol | | Ethylene/Vinyl | | | | Kuraray |
| Copolymer | | Acetate Copolymer | | | | |
| Polyethylene, | LDPE | Polyethylene Low | 0.7 | 0.8 | 0.9 | Westlake |
| Low Density | | Density | | | | Chemical |
| | | Homopolymer- with | | | | |
| | | a processing aid | | | | |
| Color | LLDPE-color | Orange in | — | — | — | Ampacet |
| Concentrate, | | Polyethylene, Linear | | | | |
| Orange | | Low Density | | | | |

Samples of extruded blown film were used to make a pouch for cooking a food product. These pouches had controlled venting after being microwaved. Pouches were made on a VFFS machine with one longitudinal seal and a first and second transverse seal at opposite ends of the pouch. The formulation of the prepared samples, including the polybutylene (PB) ranges, are listed in Table 2 below.

TABLE 2

| | | | Extrusion and |
|---|---|---|---|
| | | Thickness | finished |
| | Layer Composition | (%) | (mils) |
| Film A Layer | | | |
| 1 | 54% LLDPE, 18% EVA Copolymer, | 30.00 | 1.05 |
| (sealant layer) | 5-30% Polybutylene, Butene/Ethylene | | |
| | Copolymer, 5% LLDPE-block | | |
| 2 | 100% LLDPE-md | 10.00 | 0.35 |
| 3 | 100% PA-6, Lubricated and | 10.00 | 0.35 |
| | Nucleated | | |
| 4 | 100% EVA Copolymer | 10.00 | 0.35 |
| 5 | 100% PA-6, Lubricated and | 10.00 | 0.35 |
| | Nucleated | | |
| 6 | 100% LLDPE-md | 10.00 | 0.35 |
| 7 | 66% Polyethylene, Linear Low | 20.00 | 0.70 |
| | Density Ethylene/Octene Copolymer, | | |
| | 22% LDPE, 5% LLDPE-block 6% | | |
| | LLDPE-color, 1% Fluoropolymer | | |
| | in Polyethylene | | |
| Film B Layer | | | |
| 1 | 54% LLDPE, 18% EVA Copolymer, | 22.00 | 1.05 |
| (sealant layer) | 5-30% Polybutylene, Butene/Ethylene | | |
| | Copolymer, 5% LLDPE-block | | |
| 2 | 100% LLDPE-md | 10.00 | 0.35 |
| 3 | 100% PA-6, Lubricated and | 14.00 | 0.35 |
| | Nucleated | | |
| 4 | 100% EVA Copolymer | 10.00 | 0.35 |
| 5 | 100% PA-6, Lubricated and | 14.00 | 0.35 |
| | Nucleated | | |
| 6 | 100% LLDPE-md | 10.00 | 0.35 |
| 7 | 66% Polyethylene, Linear Low | 20.00 | 0.70 |
| | Density Ethylene/Octene Copolymer, | | |
| | 22% LDPE, 5% LLDPE-block 6% | | |
| | LLDPE-color, 1% Fluoropolymer | | |
| | in Polyethylene | | |

Variations of the film described in Table 2 were prepared. Two series of tests were completed. First, pouch samples were tested at varying PB levels in the film to identify the successful range needed of the PB to ensure a controlled venting product. Pouch samples made of the film as described in Table 2 with 10, 15 and 20% PB were tested for initial ease of opening test in the microwave. Secondly, pouch samples of 20% PB were tested in a microwave to identify successful controlled venting with food product volume of product to pouch area ratio. Both tests were based on venting performance of the pouch and ranked 1 to 3 as seen in Table 3 below.

TABLE 3
Venting Scores

| | | | |
|---|---|---|---|
| 1 | Successful | Controlled venting | Seal vented gently with no |
| | Vent | | product leaving pouch |
| 2 | Aggressive | Vented but not | Product exerted out of |
| | vent | controlled | pouch; leaving residue in |
| | | | microwave outside of the |
| | | | pouch |
| 3 | Failed Vent | Did not vent from | Pinhole or side blow out of |
| | | end seal | the pouch |

### Example 2: Varying amount of Polybutylene Tested

Pouch samples were prepared on a VFFS machine (Cryovac® Onpack 2050 as described above using 230 mm or 350 mm tooling. Pouches' end seals (5 rib seal) were sealed at 165° C. for 0.75 s. The longitudinal seal, a center lap seal, was sealed at 150° C. Pouch samples were made at various lengths and various volumes of different viscous food products. Pouch samples made of 10, 15, and 20% polybutylene (n=5) were tested in a 1250-1300 watt microwave. Pouch samples were filled with water and set in a cup with one end seal exposed up and the other seal laying at the bottom of the cup. Pouch samples were tested one at a time. Pouch samples were examined based on success of venting as described in the scale in Table 4.

Pouch samples made of 10% PB were aggressive when opening. When these pouches were heated, the sealant layer did not peel apart the seal and caused a body break causing venting from the side of the pouch. This venting on the side of the pouch was not considered a controlled vent since the water leaked out of the vent.

TABLE 4

| Polybutylene | | Success/failure | |
|---|---|---|---|
| level (%) | Sample | ranking | Description |
| 10 | 1 | 3 | body break |
| 10 | 2 | 3 | pinhole |
| 10 | 3 | 3 | body break |
| 10 | 4 | 3 | body break |
| 10 | 5 | 3 | pinhole |

Table 5 below has the results for the pouch samples used with a film having 15% PB. Pouch samples made of 15% PB performed better than the 10%, but still had lack of control when venting.

TABLE 5

| Polybutylene | | Success/failure | |
|---|---|---|---|
| level (%) | Sample | ranking | Description |
| 15 | 1 | 3 | pinhole |
| 15 | 2 | 2 | vented but |
| | | | splashed |
| 15 | 3 | 2 | vented but |
| | | | splashed |
| 15 | 4 | 1 | successful |
| 15 | 5 | 3 | pinhole |

Pouch samples made of 20% PB performed in a control manner and prevented product from inside the pouch to splash. Venting of the end seal was gentle when opening. This formulation is what was continued on to Test 2. Results for 20% PB are shown below in Table 6.

TABLE 6

| Polybutylene | | Success/failure | |
|---|---|---|---|
| level (%) | Sample | ranking | Description |
| 20 | 1 | 2 | splashed a little |
| 20 | 2 | 1 | good |
| 20 | 3 | 1 | good |
| 20 | 4 | 1 | good |
| 20 | 5 | 1 | good |

### Example 3: Food testing with 20% Polybutylene

Pouch samples made of 20% PB were tested with three food products: water, macaroni and cheese, and mashed potatoes, of various viscosity and at different pouch lengths (mm) and food product volume (fl oz). These samples were tested in a 1250-1300 watt microwave, placed in a cup, and tested one at a time. Products were ranked on the 1 to 3 scale (Table 3).

Water is viewed as a more difficult product to test because of its higher heat capacity. It takes more energy to heat water than other food products. As seen in Table 7, as the volume of water was increased, the vent became more aggressive with a smaller pouch length. This was considered the worst-case scenario product.

TABLE 7

| Food Product | 210 mm | 220 mm | 230 mm | 240 mm |
|---|---|---|---|---|
| Volume | film width | film width | film width | film width |
| 8 fl oz | 1 | 1 | 1 | 1 |
| | 1 | 1 | 1 | 1 |
| | 1 | 1 | 1 | 1 |
| | 1 | 1 | 1 | 1 |
| | 1 | 1 | 1 | 1 |
| | 1 | 1 | 1 | 1 |
| | 1 | 1 | 1 | 1 |
| | 1 | 1 | 1 | 1 |
| | 1 | 2 | 1 | 1 |
| Average | 1 | 1.1 | 1 | 1 |
| 10 fl oz | 1 | 2 | 1 | 1 |
| | 1 | 1 | 1 | 1 |
| | 2 | 1 | 1 | 1 |
| | 2 | 1 | 1 | 1 |
| | 2 | 2 | 1 | 1 |
| | 1 | 2 | 1 | 1 |
| | 2 | 3 | 1 | 1 |
| | 1 | 2 | 1 | 2 |
| | 2 | 1 | 1 | 2 |
| | 1 | 1 | 1 | 1 |
| Average | 1.5 | 1.6 | 1 | 1.2 |
| 12 fl oz | | 2 | 1 | 1 |
| | | 2 | 1 | 1 |
| | | 2 | 1 | 1 |
| | | 2 | 2 | 2 |
| | | 1 | 1 | 1 |
| | | 2 | 1 | 1 |
| | | 2 | 1 | 1 |
| | | 1 | 2 | 3 |
| | | 2 | 1 | 1 |
| | | 2 | 1 | 2 |
| Average | | 1.8 | 1.2 | 1.4 |

Table 8 shows the data for microwaving macaroni and cheese. Since the pouch samples were made with a food product of greater viscosity than water, larger food product volumes and lengths were seen as successful. Pouch samples vented in a controlled manner with no food product exiting the pouch.

TABLE 8

| Food Product | 210 mm | 220 mm | 230 mm | 240 mm |
|---|---|---|---|---|
| Volume | film width | film width | film width | film width |
| 8 fl oz | | 1 | | |
| | | 1 | | |
| | | 1 | | |
| | | 1 | | |
| | | 1 | | |
| Average | | 1 | | |
| 10 fl oz | 1 | 1 | | |
| | 1 | 1 | | |
| | 1 | 1 | | |
| | 1 | 1 | | |
| | 1 | 1 | | |
| Average | 1 | 1 | | |
| 12 fl oz | | 1 | | |
| | | 1 | | |
| | | 1 | | |
| | | 1 | | |
| | | 1 | | |
| Average | | 1 | | |
| 13 fl oz | | 1 | 1 | |
| | | 1 | 1 | |
| | | 1 | 1 | |
| | | 1 | 1 | |
| | | 1 | 1 | |
| Average | | 1 | 1 | |
| 14 fl oz | | 1 | 1 | 1 |
| | | 1 | 1 | 1 |
| | | 1 | 1 | 1 |
| | | 1 | 1 | 1 |
| | | 1 | 1 | 1 |
| Average | | 1 | 1 | 1 |
| 16 fl oz | | 1 | 1 | 1 |
| | | 1 | 1 | 1 |
| | | 1 | 1 | 1 |
| | | 1 | 1 | 1 |
| | | 1 | 1 | 1 |
| Average | | 1 | 1 | 1 |

Table 9 shows the data for microwaving mashed potatoes. Since the pouch samples were made with food product of greater viscosity than water and macaroni and cheese, larger food product volumes and lengths were seen successful. Samples vented in a controlled manner with no food product exiting the pouch.

TABLE 9

| Food Product | 210 mm | 220 mm | 230 mm | 240 mm |
|---|---|---|---|---|
| Volume | film width | film width | film width | film width |
| 14 fl oz | | 1 | 1 | 1 |
| | | 1 | 1 | 1 |
| | | 1 | 1 | 1 |
| | | 1 | 1 | 1 |
| | | 1 | 1 | 1 |
| Average | | 1 | 1 | 1 |
| 16 fl oz | | 1 | 1 | 1 |
| | | 1 | 1 | 1 |
| | | 1 | 1 | 1 |
| | | 1 | 1 | 1 |
| | | 1 | 1 | 1 |
| Average | | 1 | 1 | 1 |

The surface areas of the pouches were calculated at each different film width and are listed in Table 10.

TABLE 10

| | 210 mm | 220 mm | 230 mm | 240 mm | 300 mm |
|---|---|---|---|---|---|
| | width film | width film | width film | width film | width film |
| Length (mm) | 180 | 190 | 200 | 210 | 270 |
| Surface Area | 55.8 | 58.9 | 62 | 65.1 | 133.9 |
| (in²) | | | | | |
| Surface Area | 36000 | 38000 | 40000 | 42000 | 86400 |
| (mm²) | | | | | |

The surface area to food product volume ratio was calculated from 8 fl oz to 16 fl oz and the results are listed in Table 10. For all successful vents, pouches which had a scored 1, the surface area/food product volume is disclosed in Table 11 and 12 below. With water being a more difficult product to test because of its higher heat capacity and lower viscosity, it is assumed that successful venting with water would also be successful for macaroni and cheese mashed potatoes and partially cooked pasta. The partially cooked pasta identified in Table 11 is penne pasta boiled for 7 minutes, drained and rinsed with cool water to stop the cooking process. The pasta is then packaging with 1 fluid ounce of water. The partially cooked pasta food product volume is the combined weight of the food product plus 1 fluid ounce of water. For example, a food product volume of 8 fluid ounces would be 7 fluid ounces of pasta and 1 fluid ounce of water. Specific food product tested is seen in Table 11.

TABLE 11

| | 210 mm | 220 mm | 230 mm | 240 mm film | 300 mm film |
|---|---|---|---|---|---|
| | film width | film width | film width | width | width |
| | Surface | Surface | Surface | Surface | Surface |
| Food | Area/Food | Area/Food | Area/Food | Area/Food | Area/Food |
| product | product | product | product | product | product |
| volume | volume | volume | volume | volume | volume |
| (fl oz) | (in²/fl oz) | (in²/fl oz) | (in²/fl oz) | (in²/fl oz) | (in²/fl oz) |
| 6 | | | | 10.85^{d} | 22.32^{d} |
| 8 | 6.98^{a} | 7.36^{a, b} | 7.75^{a} | 8.14^{a} | 16.74^{d} |
| 10 | 5.58^{a, b} | 5.89^{a, b} | 6.2^{a} | 6.51^{a} | 13.39^{d} |
| 12 | 4.65^{b} | 4.91^{a, b} | 5.17^{a} | 5.43^{a} | 11.16^{d} |
| 13 | n/a | 4.53^{b} | 4.77^{b} | 5.01^{b} | 10.30^{d} |
| 14 | n/a | 4.21^{b, c} | 4.43^{b, c} | 4.65^{b, c} | |
| 16 | n/a | 3.68^{b, c} | 3.88^{b, c} | 4.07^{b, c} | |

^{a}Water testing,
^{b}Macaroni and cheese testing,
^{c}Mashed potatoes testing,
^{d}Partially cooked pasta

TABLE 12

| | 210 mm | 220 mm | 230 mm | 240 mm | 300 mm |
|---|---|---|---|---|---|
| | film width | film width | film width | film width | film width |
| | Surface Area/ | Surface Area/ | Surface Area/ | Surface Area/ | Surface Area/ |
| Food product | Food product | Food product | Food product | Food product | Food product |
| volume | volume | volume | volume | volume | volume |
| (ml) | (mm²/ml) | (mm²/ml) | (mm²/ml) | (mm²/ml) | (mm²/ml) |
| 177.4 | | | | 236.7^{d} | 486.9^{d} |
| 236.6 | 152.3^{a} | 160.6^{a, b} | 169.1^{a} | 177.6^{a} | 365.2^{d} |
| 295.7 | 121.7^{a, b} | 128.5^{a, b} | 135.3^{a} | 142.0^{a} | 292.1^{d} |
| 354.9 | 101.4^{b} | 107.1^{a, b} | 112.8^{a} | 118.5^{a} | 243.5^{d} |
| 384.5 | n/a | 98.8^{b} | 104.1^{b} | 109.3^{b} | 224.7^{d} |
| 414.0 | n/a | 91.8^{b, c} | 96.6^{b, c} | 101.4^{b, c} | |
| 473.2 | n/a | 80.3^{b, c} | 84.6^{b, c} | 88.8^{b, c} | |

^{a}Water testing,
^{b}Macaroni and cheese testing,
^{c}Mashed potatoes testing,
^{d}Partially cooked pasta

Data was not collected for samples made with 210 mm film width and 13, 14, 16 fl oz of food product due to limitation of the VFFS machine fill.

As seen in Table 11, the surface area to food product volume ratio of successful vents ranged from 3.68 to 22.32 fl oz/in². In conclusion, the range of surface area to food product volume ratio for successful controlled vents in the disclosed pouch was 3:1 to 23:1.

We claim:

1. A pouch for cooking a food product comprising:
a film;
a longitudinal seal so as to form a sealed tube;
a first transverse seal at a first end of the pouch;
a second transverse seal at a second end of the pouch; and
wherein the pouch has a surface area to food product volume ratio from 3:1 to 23:1, wherein the pouch has at least one layer with at least 5% polybutylene, wherein the longitudinal seal extends from the first end of the pouch to the second end of the pouch, and wherein the longitudinal seal seals the film to itself.

2. The pouch of claim 1, wherein the film has a sealant layer.

3. The pouch of claim 2, wherein the sealant layer has from 5% to 30% polybutylene.

4. The pouch of claims 2, wherein the sealant layer has at least 15% polybutylene.

5. The pouch of claim 2, wherein the sealant layer with polybutylene is an inside layer of the pouch.

6. The pouch of claim 1, wherein the pouch has a surface area to food product volume ratio of at least 3:1

7. The pouch of claim 1, wherein the pouch has a surface area to food product volume ratio from 3.5:1 to 8:1.

8. The pouch of claim 1 wherein the longitudinal seal is a center lap seal.

9. The pouch of claim 1, wherein the pouch has a length of 150 mm to 310 mm.

10. The pouch of claim 1, wherein the pouch has a width of 75 mm to 160 mm.

11. The pouch of claim 1, wherein the film is a multilayer film having multiple layers.

12. The pouch of claim 1, wherein the pouch is filled with a food product.

13. The pouch of claim 12, wherein the food product comprises at least one member selected from the group consisting of water, macaroni and cheese, mashed potatoes, diced vegetables, diced fruit, eggs, soup, gravy, sauces, whole meat, diced meat, rice, grains, non-sauced pasta, partially cooked pasta, pasta/sauce blends, whole vegetables, fruit fillings, fruit syrups, and ground meat.

14. The pouch of claim 11, wherein at least one layer of the multilayer film comprises at least 10% of a nylon homopolymer or nylon copolymer.

15. The pouch of claim 1, wherein either the first traverse seal or the second travers seal creates a controlled vent during cooking.

16. A method for preparing a pouch for cooking comprising:
preparing a pouch, the pouch comprising:
a film,
a longitudinal seal so as to form a sealed tube,
a first transverse seal at a first end of the pouch, and
a second transverse seal at a second end of the pouch,
wherein the pouch has a surface area to food product volume ratio from 3:1 to 23:1, wherein the pouch has at least one layer with at least 5% polybutylene, wherein the longitudinal seal extends from the first end of the pouch to the second end of the pouch, and wherein the longitudinal seal seals the film to itself
sealing the pouch at a first end with a first transverse seal filling the pouch with a food product; and
sealing the pouch at a second end with a second transverse seal,
wherein the second end is opposite of the first end of the pouch.

17. The method of claim 16, wherein the pouch has a surface area to food product volume ratio from 3.5:1 to 8:1.

18. The method of claim 16, wherein the pouch has a sealant layer.

19. The method of claim 18, wherein the sealant layer has at least 15% polybutylene.

20. The method of any one of claims 16, wherein the step of filling the pouch with a food product is filled by means of a vertical form-fill-seal (VFFS) machine.
